(19) United States
(12) Patent Application Publication
(10) Pub. No.: US 2012/0072253 A1
(43) Pub. Date: Mar. 22, 2012

(54) OUTSOURCING TASKS VIA A NETWORK

(75) Inventors: Jordan Ritter, San Francisco, CA (US); Alexander Edelstein, San Francisco, CA (US)

(73) Assignee: SERVIO, INC., San Francisco, CA (US)

(21) Appl. No.: 13/239,219

(22) Filed: Sep. 21, 2011

Related U.S. Application Data
(60) Provisional application No. 61/403,834, filed on Sep. 21, 2010.

(51) Int. Cl. G06Q 10/06

(52) U.S. Cl. 705/7.13

(57) ABSTRACT

Using a distributed set of unsupervised workers to produce a work product is disclosed. In some embodiments, a work product is received. A review task to review the work product is provided to a reviewing worker included in the set of unsupervised workers. A result of the review task is received. A determination is made, based at least in part on the review result, whether the work product satisfies an acceptance criteria.

### CROSS REFERENCE TO OTHER APPLICATIONS

This application claims priority to U.S. Provisional Patent Application No. 61/403,834 entitled OUTSOURCING TASKS VIA A NETWORK filed Sep. 21, 2010 which is incorporated herein by reference for all purposes.

### BACKGROUND OF THE INVENTION

Online “crowdsourcing” and other outsourcing services enable work requestors to access a flexible and potentially large pool of unsupervised human workers. The Mechanical Turk crowdsourcing marketplace service offered by Amazon.com, Inc. is an example (see www.mturk.com). To date, such services typically have been used to recruit unsupervised online human workers to perform relatively low skill and/or repetitive tasks that a human is considered to be better than a computer or other machine at performing. Examples include editing written content, rating a website or other web-based content, and identifying duplicative content.

Typical services do not provide effective mechanisms to ensure the quality, accuracy, etc. of the specific work product produced in response to a particular task. In the case of Mechanical Turk, for example, a requestor's recourse if a task is not performed to the requestor's satisfaction is to refuse payment. Some attempts have been made to identify and ban workers who game the system and/or do not do good work. Statistical methods, such as statistical classifiers, have been used to determine which of a plurality of individual, separate responses to the same task are correct. But typically no reliable mechanism is provided to ensure that work produced by a particular worker in response to a specific task request satisfies acceptance criteria.

### BRIEF DESCRIPTION OF THE DRAWINGS

Various embodiments of the invention are disclosed in the following detailed description and the accompanying drawings.

FIG. 1 is a block diagram illustrating an embodiment of a system to outsource work.

FIG. 2 is a flow diagram illustrating an embodiment of a process to outsource work.

FIG. 3 is a flow diagram illustrating an embodiment of a process to outsource tasks.

FIG. 4 is a block diagram illustrating an embodiment of a work completion system.

FIG. 5A is a flow diagram illustrating an embodiment of a process to edit content.

FIG. 5B is a block diagram illustrating an embodiment of a task completion and review pattern.

FIG. 5C is a block diagram illustrating an embodiment of a task completion and review pattern.

FIG. 6A is a flow diagram illustrating an embodiment of a process to create content.

FIG. 6B is a block diagram illustrating an embodiment of a task completion, machine check, and human review pattern.

FIG. 7A is a flow diagram illustrating an embodiment of a process to translate content.

FIG. 7B is a block diagram illustrating an embodiment of a business process flow to perform translation, as in the process of FIG. 7A.

FIG. 7C is a block diagram illustrating an embodiment of chaining task patterns to produce a workflow.

FIG. 8 is a flow diagram illustrating an embodiment of a process to provide tasks to workers.

FIG. 9 is a flow diagram illustrating an embodiment of a process to outsource work.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Automating work performed at least in part by a distributed set of unsupervised workers is disclosed. In various embodiments, a review of work is caused to be performed by reviewers drawn from the distributed set of unsupervised workers. Review results along with reputation data for both the originating worker and the reviewer(s) is used to determine programmatically whether to accept the work performed by the originating worker.

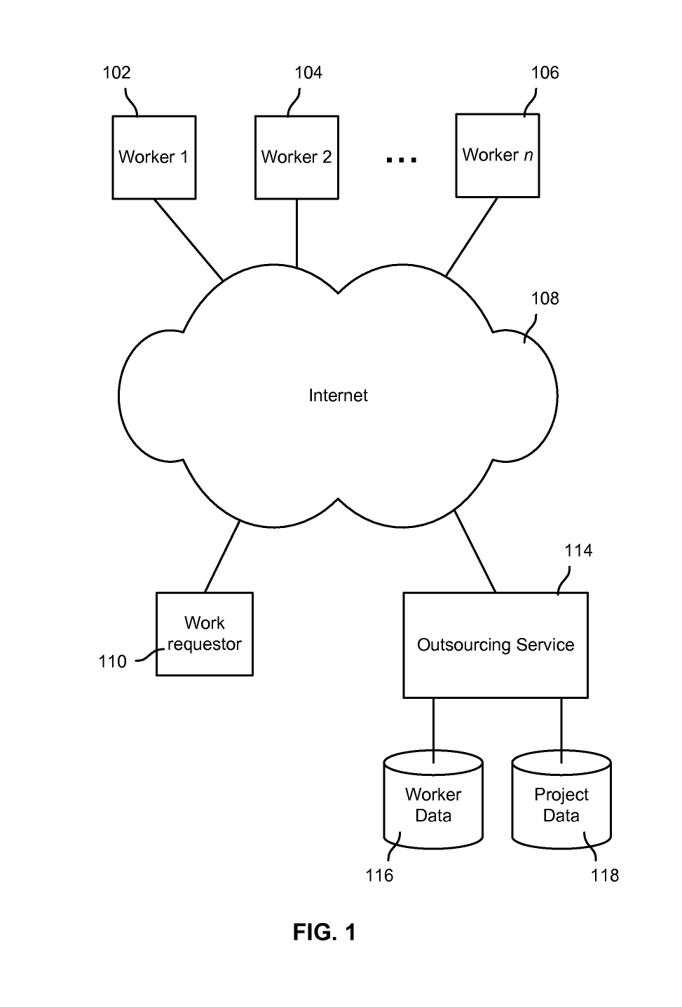

FIG. 1 is a block diagram illustrating an embodiment of a system to outsource work. In the example shown, Internet users associated with worker client systems 1 to n, represented in FIG. 1 by worker client systems 102, 104, and 106, have access to the Internet 108. Similarly, work requestors, represented in FIG. 1 by work requestor client system 110, are connected to the Internet 108. In the example shown, an outsourcing service 114 is connected to the Internet 108. Service 114 maintains data on registered outsource workers in a worker database 116 and maintains in a project data store 118 task and business process flow data related to work that work requestors have requested to be performed. In various embodiments, service 114 uses project data 118 to define and post discrete tasks to be performed by outsource workers. A task in various embodiments may be any discrete work item to be performed. Examples of worker user interfaces include web interfaces provided by the service 114 via a service-operated web page and worker interfaces provided via a social network application. Workers associated with clients such as 102, 104, and 106 browse available tasks via the worker interface and, if they find a task they are interested in performing, select the task and perform the associated work as instructed. If the work is accepted, the worker is paid, in some embodiments immediately via a micropayment, for the work.

A work request may be submitted by a work requestor. For example, a user associated with work requestor client system 110 may request that work be performed, such as a request to proofread a blog entry before the user posts the entry. In some embodiments, a widget or other tool is provided via a blog entry creation interface to enable an “edit” of the entry (or other text) to be requested, for example by clicking on an “edit” button. In other embodiments, a tools menu such as a pull down or popup menu includes an option to “edit” content. Automatically on selection of the “edit” option, the text in question and a request to edit the request is generated and sent to the service 114. A business process flow instance is created to manage performance of the work. Depending on the amount of text and how the business process and/or service 114 are configured, the text may be broken into subparts, for example paragraphs, sentences, or other parts, and for each subpart a task defined and posted to edit that part. Once all the component tasks have been completed, the work done by the various workers who completed the tasks is combined to generate and deliver to the work requestor an edited version of the original text.

In some embodiments, a work requestor such as one associated with work requestor client system 110 uses a work request interface, such as a graphical user interface, a web services interface, and/or an API, to request that work be performed. As in the example above, the service 114 creates an instance of a business process flow to manage performance of the work through completion. The business process flow invokes a work completion platform to cause required work to be performed. The work completion platform instantiates its own workflow to manage completion of the required work, the result of which is returned to the crowdsourcing service business process flow, which assembles and delivers the final work product to the work requestor, initiates payment by the work requestor, etc. The business process flow and/or the work completion workflow or both may enter a wait state while a component flow or sub-flow executes. Upon completion of execution of the component flow or sub-flow, processing at the next level up in the workflow resumes. Multiple component flows and/or processes may in some cases execute in parallel. A first workflow may invoke a second workflow which may invoke a third workflow, and so on, to any arbitrary depth as may be required to perform work required to produce a final work output of the overall business process flow.

Automatically obtaining a review of work to determine whether the work meets acceptance criteria is disclosed. Upon completion of a task by an originating worker, in various embodiments one or more review tasks are generated automatically, to be performed by one or more reviewing workers from a set of unsupervised, remote workers. In some embodiments, to originating worker is a member of the set of unsupervised, remote workers. In some embodiments, an original task has a review task counterpart usable to determine whether the original work satisfies acceptance criteria. For example, an original task to write a headline for an article or other content may have an associated review task to determine, given the content and the headline provided by the original task performer, whether the headline fits the content. Based at least in part on the input received from one or more reviewers, a decision is made programmatically whether the work performed by the originating worker satisfies applicable acceptance criteria. If so, the work is accepted and the originating worker and reviewers who agreed the work met acceptance criteria are paid. If not, the work is caused to be redone by another worker, and so on, until the work has been completed in a manner that meets acceptance criteria.

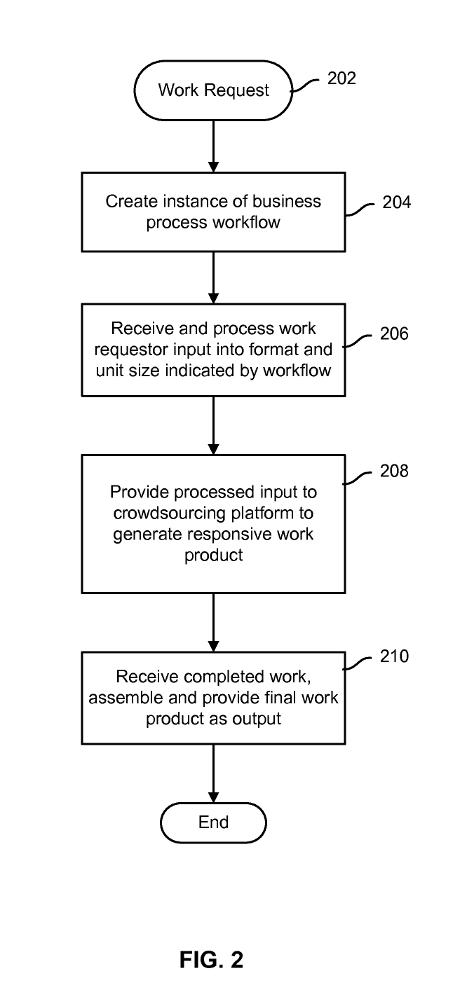

FIG. 2 is a flow diagram illustrating an embodiment of a process to outsource work. In various embodiments, the process of FIG. 2 is implemented by a work-requestor facing interface and service of an online outsourcing service such as service 114 of FIG. 1. In the example shown, on receiving a work request (202) an instance of a business process flow configured to manage completion of the requested work is created (204). For example, a business process template is created in some embodiments by persons knowledgeable about a type of work request desired to be supported. The template defines discrete tasks and how attributes of those tasks are to be determined at runtime, for example by associating input data provided by a requestor (or portions thereof) with specific work to be done. An instance of the business process manages performance of a particular work request from start to finish, including by invoking a work completion platform to cause specific tasks to be performed by members of the outsource labor pool.

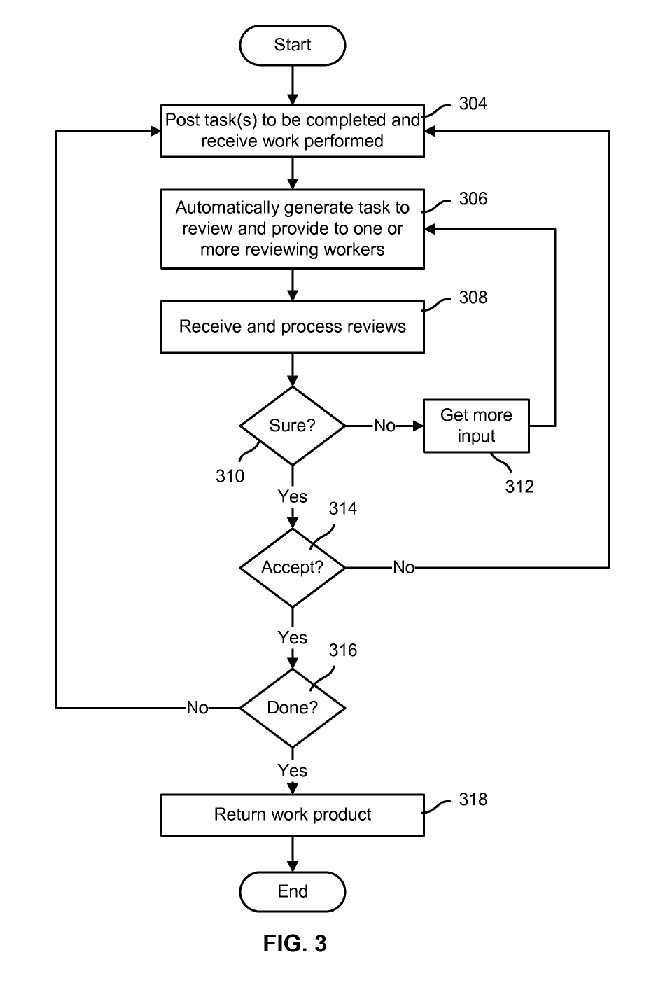

The business process flow instance receives and processes input received from the work requestor to enable the work to be performed (206). Examples include without limitation a document or other content to be edited; text to be translated; and information obtained from the work requestor to be used to create content, such as a press release. The input data is processed into a format and/or unit size indicated by the business process flow as being required to complete the work. For example, text to be edited may be divided up into pages or other subdivisions of a prescribed unit size, to enable the work completion platform to assign each page separately to be edited in parallel. Or, input data provided by a work requestor may be parsed and reformatted for consumption by the work completion platform, such as xml or other structured data. The processed input data is provided to a work completion platform to cause specific work to be done, for example by calling an “edit” or other service of the work completion platform and providing the respective pages of input as objects on which the “edit” work is to be performed (208). The business process flow instance enters a waiting state while the work completion platform causes the work to be performed, in some embodiments as described below in connection with FIG. 3. The business process flow receives the completed work from the work completion platform, such as the edited pages in the example mentioned above, and assembles and delivers to the work requestor the final work product (210).

FIG. 3 is a flow diagram illustrating an embodiment of a process to outsource tasks. In various embodiments, the process of FIG. 3 is implemented by a worker-facing work completion platform of an online outsourcing service such as service 114 of FIG. 1. In the example shown, upon receiving from a business process flow a request to perform specific work the business process flow instance has been created to cause to be performed, one or more discrete tasks required to complete the work are made available to workers to perform, and as each task is completed the work product created by the worker who completed the task is received (304). In some embodiments, workers earn credentials and/or levels of credential by passing a qualifying test. A task may indicate a credential and/or level that a worker must have to be eligible to perform the task. A task may also indicate a minimum applicable reputation score, required demographic and/or psychographic status, etc. required to be eligible to perform the task. The task is only visible in some embodiments to workers eligible to perform the task. In some embodiments, tasks a worker is not (yet) eligible to perform may be shown to a worker but in another color or with some other visual indication that the worker is not eligible to perform that task, for example to induce the worker to aspire to achieve a higher level of credential.

Upon completion of a task, one or more corresponding review tasks are generated automatically (306). The respective results of the review tasks are received and processed (308). If based on the review results received so far a decision cannot be made automatically with a sufficient degree of confidence that the work should be accepted or, conversely, rejected, then more input is obtained (312). In various embodiments work on the work completion platform side is managed by a workflow configured to use an escalation strategy to be able to determine with a sufficient degree of confidence that the original work should be accepted or, conversely rejected. For example, depending on the nature of the work and how the applicable workflow has been configured, one or more additional tasks to obtain further review may be generated, or in a case in which uncertainty persists beyond a configured number of iterations, human intervention by a supervisory staff may be requested. The required degree of certainty may vary depending on factors such as the nature of the task, the sensitivity of a particular work request, for example as indicated by the requestor in the request, and/or the configured and/or indicated preferences of the work requestor.

Once a result (e.g., accept or reject) is determined with the requisite level of certainty (310), if the work was rejected then the original task is resubmitted for completion by another worker, and the task completion and review processing described above is repeated. In some embodiments, the originating worker is not paid and the originating worker's reputation is downgraded if work is rejected. The task and review cycle is repeated until the work produced is accepted. In some embodiments, timeouts or other events may trigger human intervention and/or other exception handling, for example if a task has not been completed within a prescribed time and/or within a prescribed number of attempts.

If the decision is to accept (314), then the original task is completed, and the originating and/or reviewing workers who performed their tasks correctly are paid. If other tasks remain to be performed (316), those tasks are created and caused to be performed (304, etc.). Certain tasks may have dependencies on other tasks and cannot be posted until the tasks on which they depend have been completed. For example, a review task may not be generated and/or posted until a task to generate the work that is to be reviewed has been completed. Upon submission of work product for the original task, one or more review tasks are created and the work produced by the originating worker, or a portion thereof, may be associated with the review tasks as input. Likewise, a task to edit the work product produced by one or more human and/or machine translators cannot be performed until the translation work has been completed. Conversely, an original task cannot move to completion until required review tasks have been completed and processed.

Once all tasks have been completed (316) the work produced is returned (318), for example to the business process flow that invoked the work completion platform, and the process of FIG. 3 ends.

While in the example shown in FIGS. 2 and 3 separate workflows are implemented by different platforms to receive and respond to a work request (FIG. 2) and to cause required work to be completed (FIG. 3), in other embodiments a single platform and business process flow processes and respond to a work request, including by receiving and processing the work request as in FIG. 2 and causing required work to be performed as in FIG. 3.

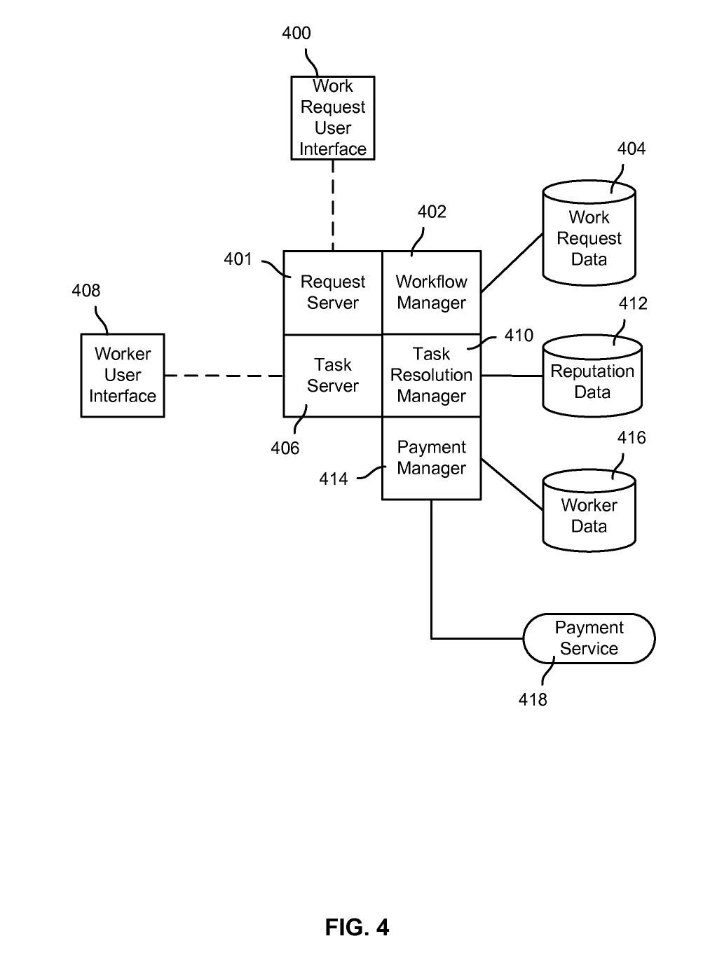

FIG. 4 is a block diagram illustrating an embodiment of a work completion system. In the example shown, a work request user interface 400 is provided to enable work requestors to submit work requests to a request processing server 401. Work requests are fulfilled by a workflow manager 402 configured to manage a business process or other workflow to complete requested work. Work requests and associated data are stored in a work request data store 404. Workflow manager 402 invokes an internal or external work completion function associated with a task server 406. A work completion workflow generates component tasks which are made available to workers via a task server 406. Workers use a worker user interface 408, for example a website, web or mobile application, social network application, etc., to view and select tasks posted by task server 406. Upon completion of a task, work is submitted by originating workers to the task server to be evaluated for acceptance by a task resolution module 410. In some embodiments, an original task and associated review tasks are processed as a task family of related tasks. Task resolution manager 410 evaluates the work performed by the originating worker based at least in part on the reviews performed by reviewing workers who completed the review tasks in the task family. In the example shown, reputation data stored in reputation data store 412 is used to evaluate the work performed. If the work is accepted, a payment manager 414 uses worker data stored in a worker data store 416 and a payment service 418, such as Paypal or another online and/or micropayment service, to pay the originating worker and/or the reviewers whose work was accepted.

In various embodiments, techniques described herein are used to perform various types of work, including without limitation editing content (e.g., proofreading), creating content, translating or otherwise transforming content, and/or more complicated work involving as subcomponents elements of some or all of the above types of work.

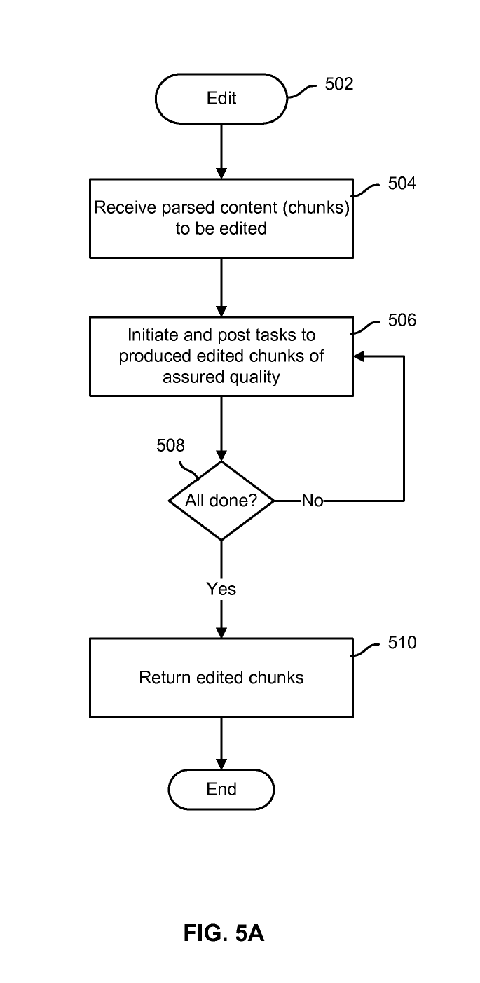

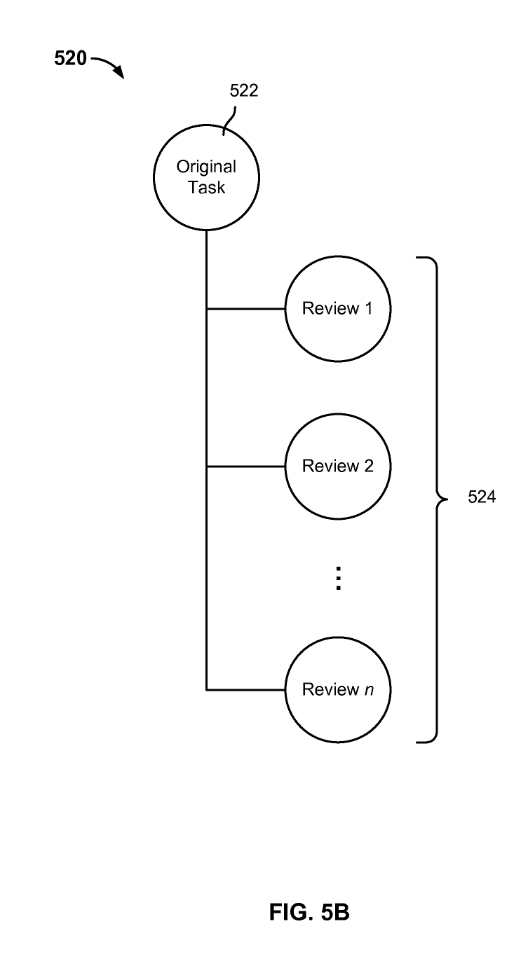

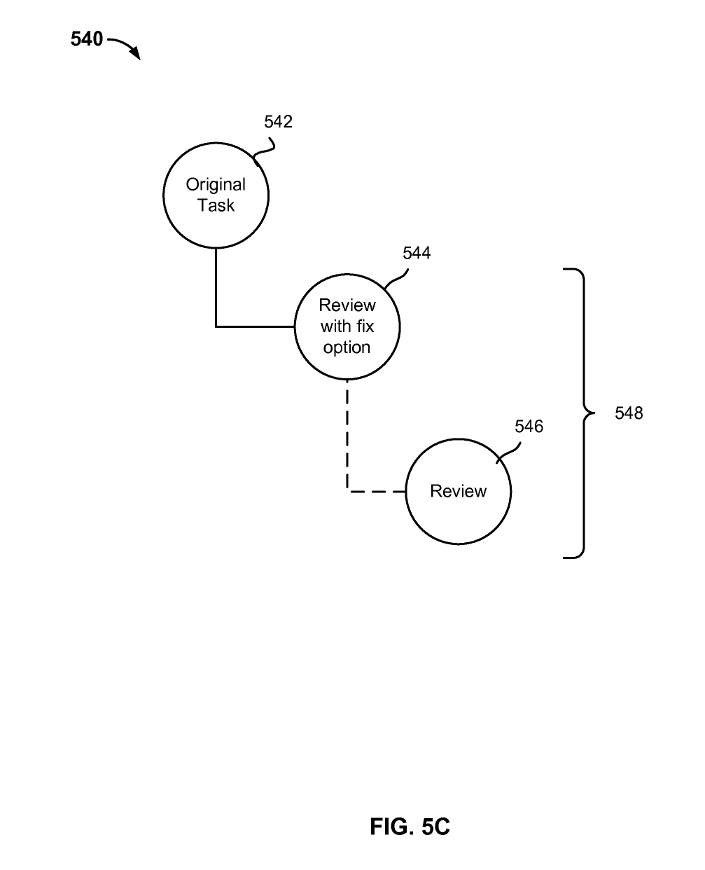

FIG. 5A is a flow diagram illustrating an embodiment of a process to edit content. In various embodiments, the process of FIG. 5 is implemented by a work completion platform and may be invoked by a business process flow configured to fulfill a work request, as described in connection with FIG. 2 above. In the example shown, a request to edit content is received (502). Parsed units of content to be edited are received (504). In some embodiments, the business process that invokes the “edit” function is configured to divide content to be edited into chunks of a desired size. In some embodiments, a document parsing engine configured to use native capabilities, features, and/or behaviors of a word processing or other application are used to determine and preserve for each chunk document formatting information, such as font, margins, line spacing, paragraph style attributes, etc. Each chunk in some embodiments comprises a document or other file of an authoring application used to create the original content. When the chunks are recombined the original formatting information determines the formatting of the final combined document, ensuring the requestor receives a final document in which the formatting of the originally submitted content has been preserved.

Tasks to edit the received content are created, posted, and tracked to completion (506). In some embodiments, review tasks to evaluate work performed by originating task performers are generated and posted as described herein. Once all the chunks have been edited (508), the edited chunks are returned, for example to the business process flow that invoked the edit function (510).

FIG. 5B is a block diagram illustrating an embodiment of a task completion and review pattern. In the example shown, the pattern 520 includes an original task 522, such as the edit task described above, and 1 to n review tasks 524 associated with the original task. Each review task comprises review work to be performed by a reviewing worker, for example one recruited from a pool of unsupervised distributed workers (i.e., crowdsourcing). The review work is designed such that a result of the review work may be used to determine whether the original work was done in a manner that meets acceptance criteria. The edit and review task family described above in connection with FIG. 5A is an example of an instance of the pattern 520.

In various embodiments, a related set of tasks such as those comprising pattern 520 are processed as a task family to determine whether the original work is to be accepted, for example as described above in connection with FIGS. 3 and 5A. A pattern in some embodiments includes or has associated with it a resolution strategy that defines the acceptance criteria that must be met for work produced in connection with the pattern to be accepted and an output (e.g., a conclusive answer set) of the pattern and/or workflow stage to be generated and provided as output, for example to a next pattern or other stage of the workflow.

FIG. 5C is a block diagram illustrating an embodiment of a task completion and review pattern. In the example shown, the pattern 540 includes an option to allow a reviewer of the work produced in an original task 542 to optionally provide one or more fixes to the original performed work in a review with fix option task 544. If the work is accepted with changes by the reviewer, the resulting work product is reviewed (e.g., in the same manner as if it were an original work) in a subsequent review task 546. In the example shown, the accept with changes result of review task 544 and subsequent review 546 of the resulting work product with changes comprise a sub-pattern 548 that can be repeated a configured number of times (i.e., to a configured depth), offering subsequent reviewers an option to accept with changes (fixes) to a configured depth before requiring a final set of one or more reviews to accept or reject, without offering them the option to accept with changes.

In various embodiments, patterns of tasks such as pattern 520 and pattern 540 comprise repeatable and/or reusable building blocks that can be chained together with other patterns of the same or different pattern types, as described further below, to build a complex, multi-stage workflow to achieve some end purpose, for example, to create a professional quality press release and reliably translate same into one or more other languages.

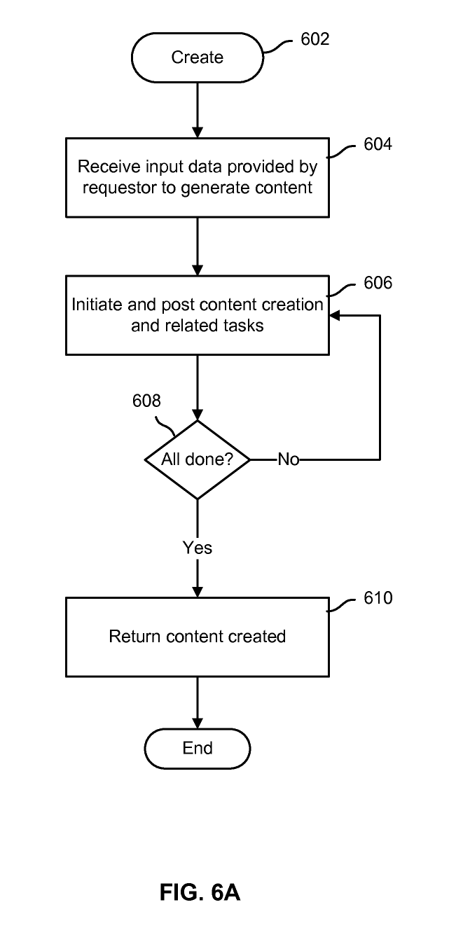

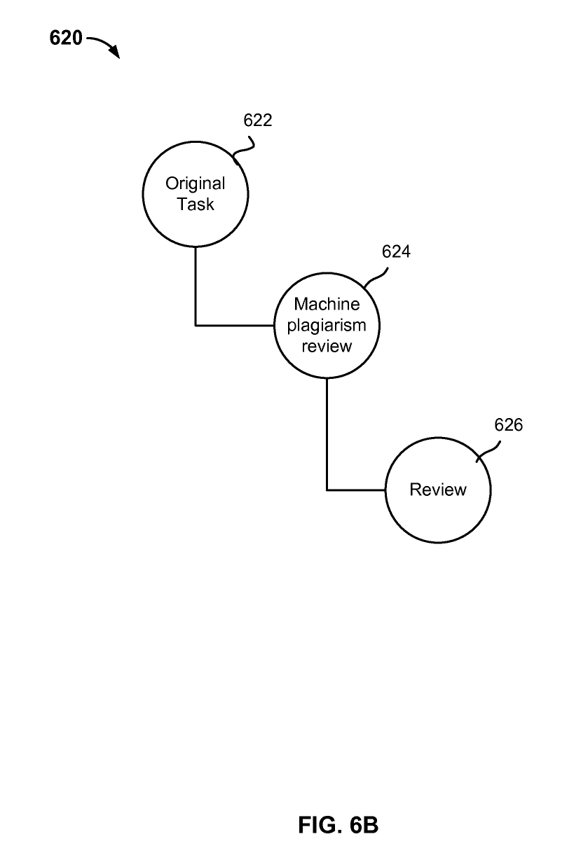

FIG. 6A is a flow diagram illustrating an embodiment of a process to create content. In the example shown, a request to create content is received (602), for example from a business process configured to fulfill a content creation work request. Input data received originally from the work requestor is received (604). For example, in the case of a press release a user interface may be provided to prompt the work requestor to identify the company making the release, the subject of the release, the CEO or other announcing representative's name, a quote or suggested quote, a stock description of the announcing company, etc. A business process flow configured to fulfill the request processes the input data and provides the processed input data to the work completion platform to enable the content to be created. Tasks required to generate the required content are made available to workers, and tracked to completion, including in various embodiments by using review by human workers to evaluate task results as disclosed herein (606). Once all tasks have been completed (608), the content is returned to the business process flow that requested it (610).

By providing, through human review, a reliable way to ensure that work meets acceptance criteria, work that requires a high degree of skill and expertise can be outsourced as disclosed herein. For example, press releases, product documentation, corporate web pages, standard and non-standard legal documents, etc., can be created. Component tasks of such projects are provided in various embodiments only to workers having the credentials, reputation score, demographic or psychographic or other information, etc. required to qualify to perform the task. For example, tasks associated with creating a legal document may be made available for assignment only to members of the applicable state bar, or tasks associated with writing a press release may be assigned only to workers who have attained an associated credential and/or level.

FIG. 6B is a block diagram illustrating an embodiment of a task completion, machine check, and human review pattern. In the example shown, the pattern 620 includes an original task 622 to create content, for example as described above. Completion of the original task 622 triggers an automated plagiarism check review task 624 that is performed by a machine. The original work and result of the machine plagiarism check are provided to one or more reviewers to complete a review task 626. The pattern 620 comprises an example of a task pattern and family that incorporates tasks performed by a machine with tasks performed by humans and, like the patterns in FIGS. 5B and 5C, is a further example of a repeatable and/or reusable pattern that can be chained with other patterns to create a complex end-to-end workflow.

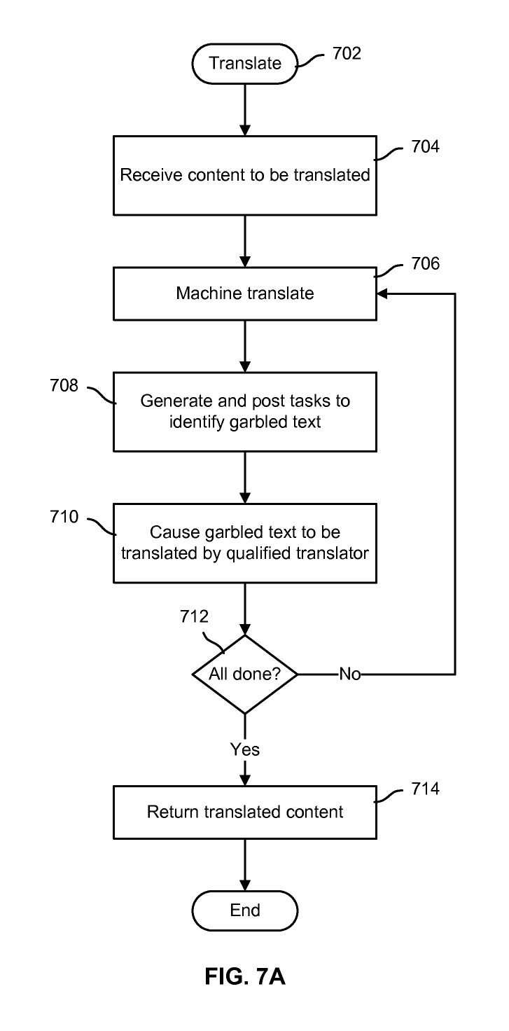

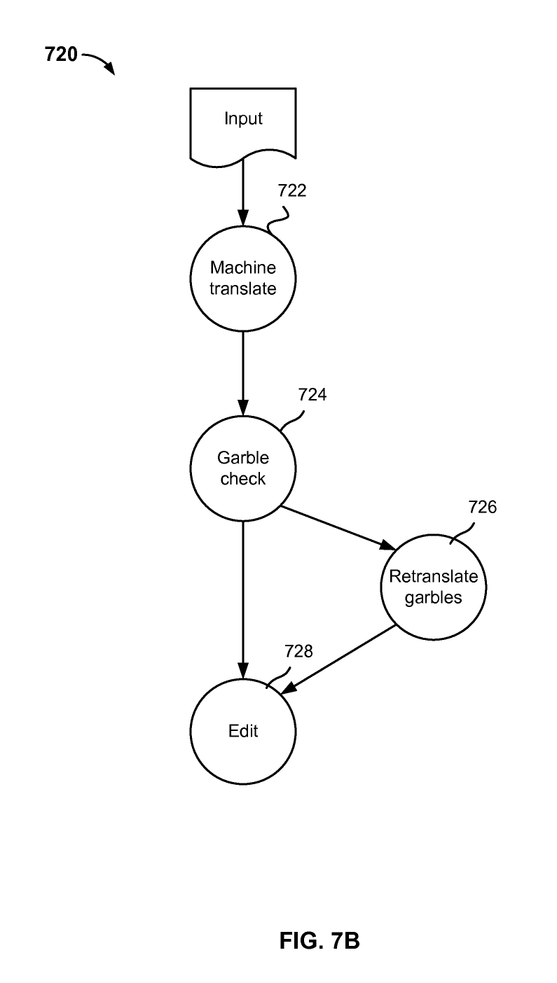

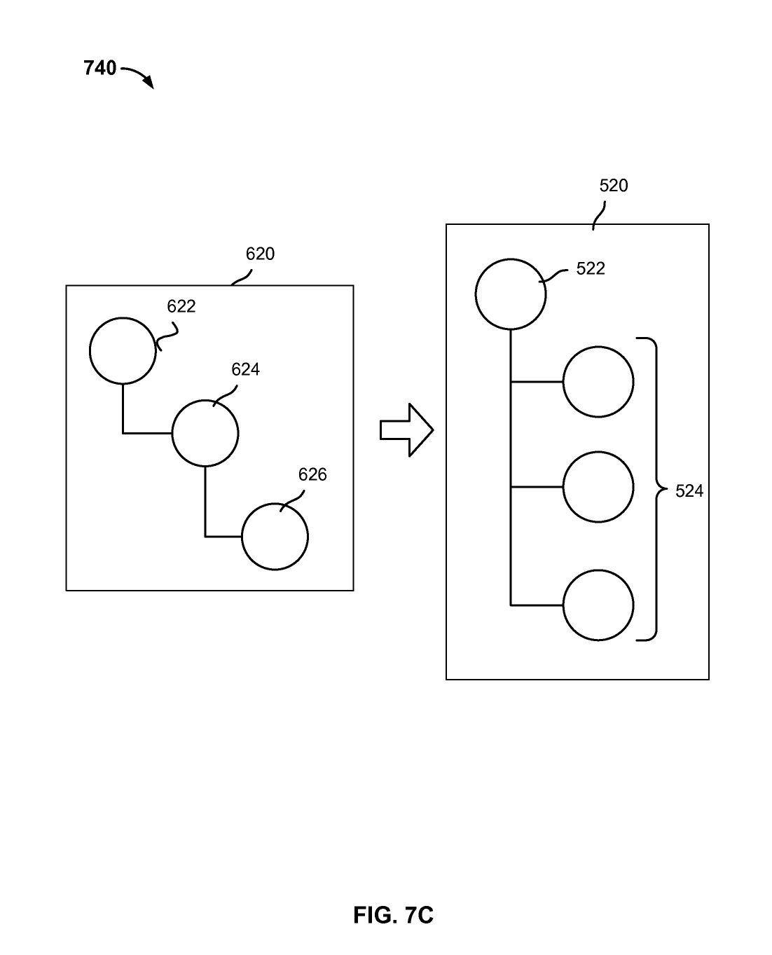

FIG. 7A is a flow diagram illustrating an embodiment of a process to translate content. In the example shown, a request to translate is received (702). The request may be received from a business process configured to fulfill a translation request. In various embodiments, the original request from the work requestor may be explicit, e.g., blogger or other content creator clicking a “translate” button, or implicit, e.g., worker saves updates to an online product description or other documentation configured to be made available in other languages. The content to be translated is divided into one or more pages or chunks of some other size, for example, sentence or paragraph or section sized chunks, by the business process flow configured to fulfill the request, and the chunks are provided to the work completion platform workflow invoked to cause the translation work to be done (704). Machine translation of the chunks is performed (706). Tasks to identify content portions, for example sentences, for which the machine generated an incorrect translation are generated and made available to be selected by workers (708). In some embodiments, native speakers of the destination language into which the original content has been translated are eligible to perform the task of identifying mistranslations. Tasks to retranslate garbled portions are created and made available to human translators to perform (710). Once all chunks have been translated (712), the translated content is returned (714), for example to the business process that called the translation service/function of the work completion platform.

FIG. 7B is a block diagram illustrating an embodiment of a business process flow to perform translation, as in the process of FIG. 7A. In the example shown, business process 720 includes an original task 722 that is performed by a machine, in this example machine translation of received content. A human-performed task 724 is performed to identified garbled (e.g., nonsensical or syntactically incorrect) portions of the content as translated by the machine. Garble hunting in some embodiments comprises a component pattern of the business process 720. For example, multiple garble hunting tasks may be assigned to be performed in parallel, each comprising an original task plus review family of tasks, as in FIG. 5B. Once a garble hunting tasks and corresponding review tasks are completed, the results are submitted for resolution. If the originating work is accepted and garbled portions were found, those portions are assigned to be translated by human translators 726. The human translator node likewise comprises a pattern, in which translation tasks are performed and reviewed and results, once accepted, are passed to the next stage. In the example shown, portions of translated content found not to contain garbles or those in which the garbled portions have been retranslated (724, 726) are passed to an editing stage 728 of the business process 720 to be edited in parallel. The editing stage comprises an edit-review pattern such as in FIG. 5B above. Once each section has been edited and the edited output accepted, the output is returned as resulting work product of the translation request. The translated portions are assembled and delivered the translation work requestor as final work product.

In the above example illustrated in FIGS. 7A and 7B, a workflow that makes optimal and integrated use of machines and human workers of the minimum skill level needed for a particular task (e.g., have a native speaker who cannot translate check the machine translation output for garbled text), via a fully automated workflow, yields accurate results for a complex task at a low cost.

FIG. 7C is a block diagram illustrating an embodiment of chaining task patterns to produce a workflow. In the example shown, a create content-machine check-review pattern 620 as in FIG. 6B has been chained with an edit-review pattern 520 as in FIG. 5B to produce a complex workflow 740. For example, content may be created, checked for plagiarism, and review in a portion of the flow implemented using pattern 620, and resulting content edited in an edit-review pattern 520. In some embodiments, a number of repeatable patterns are available to be used to create a flow such as the one shown in FIG. 7C. In some embodiments, visual developer/programming tools are provided to enable a workflow creator to chain together available task patterns to build a workflow.

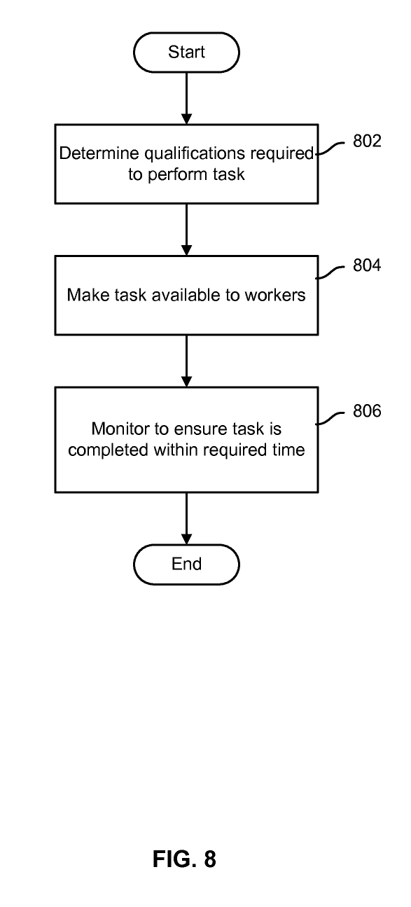

FIG. 8 is a flow diagram illustrating an embodiment of a process to provide tasks to workers. In the example shown, the qualification required to perform a task is determined (802). In some embodiments, for each worker, data is stored that reflects that user's credential, reputation, demographic, psychographic, and other information. For example, a worker may be assigned an editing credential that reflects a level of credential the worker has attained with respect to editing tasks. Tests are used in various embodiments to enable a worker to attempt to obtain a next level of relevant credential. In various embodiments, a task has associated with it a set of attributes a worker must have to qualify to perform the task. Examples included a required credential and/or level (English editor level 1); a prescribed reputation level (for example, overall and/or relevant to the work to be performed); academic, professional, or other credentials that may be required to perform the work; and demographic, psychographic, or other information about the worker. Once generated, a task is posted in a manner that renders it available to be selected and performed by a worker who meets the requirements to be eligible to perform the task (804). In some embodiments, at least some tasks a worker is not eligible to perform are displayed to the worker, but in a manner that indicates visually that the task is not available to be selected by the worker due to the worker not having the required credential. Once posted, a workflow or other process that generated the task monitors to ensure the tasks is performed accurately and on time (806). In some embodiments, if a task remains posted beyond a threshold amount of time without being taken on by a worker, an automated and/or human review and/or re-pricing may be initiated, for example to determine whether the price being offered to workers to complete the task is sufficiently high to induce workers having the required skill and/or level to perform the task and/or to ensure the required credential, level, reputation, etc. has not been set too high.

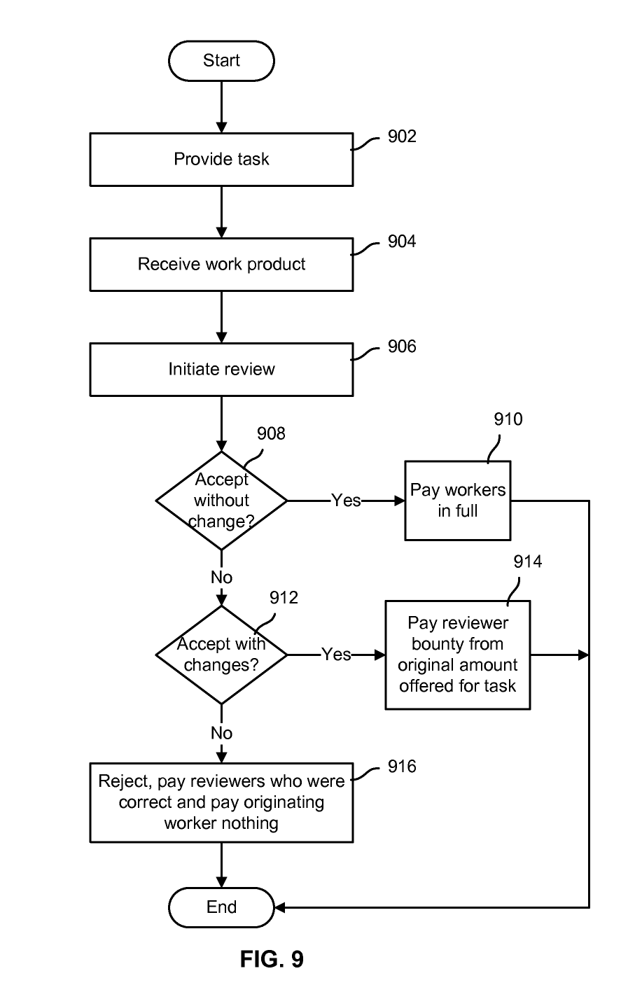

FIG. 9 is a flow diagram illustrating an embodiment of a process to outsource work. In the example shown, a task is provided (902) and work product produced by the worker to whom the task was provided is received (904). Review of the work product is initiated automatically by the outsourcing system (906), for example by creating review tasks and assigning same to one or more reviewing workers. If the result of the review process is to accept the originating worker's work product without change (908), the originating worker and reviewer workers who were correct are paid in full for the task (910). If the work is not accepted as submitted (908) but is accepted with changes made by one or more reviewing workers (912), then the worker and reviewer(s) each are paid a corresponding share of the total price offered originally to the originating worker to perform the original task (914). If the originating worker's work is not accepted fully or with changes, the work is rejected, reviewers who reached a correct result are paid, the originating worker is not paid (916) and the work is redone by another. In some embodiments, if a reviewer submits a result to accept the originating worker's work with changes, one or more tasks are generated to validate the corrections as being accurate and necessary and in some embodiments, to obtain one or more opinions as to the relative contribution of the originating worker and the reviewer(s) who submitted corrections to the originating worker's original work. The relative contribution information is used in some embodiments to determine how to share the price available to be paid for the accurate final output. In this manner, nearly but not fully acceptable work can be rendered acceptable quickly, by incorporating reviewer changes, without increasing the total amount paid to workers to complete the original task.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system to use a distributed set of unsupervised workers to produce a work product, comprising:
a communication interface; and
a processor coupled to the communication interface and configured to receive a work product; provide to a reviewing worker included in the set of unsupervised workers a review task to review the work product; receive a result of the review task; and determine based at least in part on the result whether the work product satisfies an acceptance criteria.

2. The system of claim 1, wherein the processor is further configured to generate and make available to be performed by an originating worker an original task with which the work product is associated.

3. The system of claim 2, wherein the processor is further configured to post the original task as being available to members of the distributed set of unsupervised workers to select and perform.

4. The system of claim 3, wherein the original task is posted via one or more of a webpage, a social network application, and a mobile application.

5. The system of claim 1, wherein the review task comprises one of a plurality of review tasks the processor is configured to generate to review the work product.

6. The system of claim 5, wherein the processor is configured to use the work product, the respective review results of the reviews, and reputation data of the originating worker and the reviewing workers to determine whether to accept the work product.

7. The system of claim 1, wherein the processor is further configured to reassign an original task with which the work product is associated to be redone based at least in part on a determination to reject the work product.

8. The system of claim 7, wherein the processor is further configured to return the work product to a business process that invoked a function or service with which the work product is associated, based at least in part on a determination that the work product is to be accepted.

9. The system of claim 1, wherein the processor is configured to escalate to a further level of review if the processor cannot determine with a prescribed degree of certainty whether to accept the work product.

10. The system of claim 1, wherein the work product is produced in connection with one or more of a request to edit, create, or translate content.

11. The system of claim 1, wherein the work product is produced by a machine.

12. The system of claim 11, wherein the work product comprises a machine translation result.

13. The system of claim 1, wherein the work product is reviewed by a machine prior to being received.

14. The system of claim 13, wherein the review comprises a plagiarism check.

15. The system of claim 1, wherein the work product is associated with an original task and the original task and the review task comprise a task family that the processor is configured to process and evaluate together.

16. The system of claim 1, wherein the work product is associated with an original task and the original task and the review task comprise an instance of a reusable task pattern made available to be chained with one or more other patterns or other components to create a complex workflow configured to produce an end work product.

17. The system of claim 1, wherein the processor is configured to include in the review task an option to accept the work product with changes made by the reviewing worker.

18. The system of claim 17, wherein the processor is configured to provide to each of the originating worker and the reviewing worker a corresponding share of an original amount offered to the originating worker to produce the work product, in the event a determination is made to accept the work product with changes made by the reviewing worker.

19. A method to use a distributed set of unsupervised workers to produce a work product, comprising:
receiving a work product;
providing to a reviewing worker included in the set of unsupervised workers a review task to review the work product;
receiving a result of the review task; and
determining based at least in part on the result whether the work product satisfies an acceptance criteria.

20. The method of claim 19, comprising wherein the review task comprises one of a plurality of review tasks the processor is configured to generate to review the work product.

21. The method of claim 20, further comprising using the work product, the respective review results of the reviews, and reputation data of the originating worker and the reviewing workers to determine whether to accept the work product.

22. The method of claim 19, further comprising reassigning an original task with which the work product is associated to be redone based at least in part on a determination to reject the work product.

23. The method of claim 22, further comprising returning the work product to a business is process that invoked a function or service with which the work product is associated, based at least in part on a determination that the work product is to be accepted.

24. The method of claim 19, further comprising escalating to a further level of review if it cannot be determined with a prescribed degree of certainty whether to accept the work product.

25. A computer program product to use a distributed set of unsupervised workers to produce a work product, the computer program product being embodied in a tangible, non-transitory computer readable storage medium and comprising computer instructions for:
receiving a work product;
providing to a reviewing worker included in the set of unsupervised workers a review task to review the work product;
receiving a result of the review task; and
determining based at least in part on the result whether the work product satisfies an acceptance criteria.
